(19) United States
(12) Patent Application Publication
(10) Pub. No.: US 2015/0345088 A1
(43) Pub. Date: Dec. 3, 2015

(54) Camouflage Winter Tools

(71) Applicant: Jeff Prescott, Franklin, TN (US)

(72) Inventor: Jeff Prescott, Franklin, TN (US)

(21) Appl. No.: 14/291,025

(22) Filed: May 30, 2014

(51) Int. Cl. E01H 5/02; A01B 1/02

(52) U.S. Cl. CPC E01H 5/02; A01B 1/02

(57) ABSTRACT

The invention is winter tools such as show shovels. These tools are designed to fit in and be concealed by its surroundings and environment but with a bright colored handle such as red or orange so they can be easily found. The winter tool could be painted and have texture added to match the environment such as snow.

### CROSS-REFERENCES TO RELATED APPLICATIONS (IF ANY)

None

### BACKGROUND OF INVENTION

1. Field of the Invention

The present invention is directed to a providing winter yard tools like snow shovels more particular ones that are designed to blend into its surroundings.

2. Background

Tools such as rakes, spades, cultivators, shovels and hoes and others have been used and been in existence for 1,000s of years and have been used by human to assist them in their needs.

There is a limited number of good ways currently to store yard tools where they are out of the way but still accessible.

There is still room for improvement in the art.

### SUMMARY OF THE INVENTION

The invention is a yard tool such as a rake, shovel or hoe that will be designed to fit in and be concealed by it surroundings and environment. The shovel and shaft will be designed to be concealed and the handle will be the bright Orange. The Orange serves a function so that the shovel can be found in the snow.

Further features and advantages of the invention will become apparent from the following detailed description made with reference to the accompanying drawings.

### BRIEF DESCRIPTION OF THE DRAWINGS

Without restricting the full scope of this invention, the preferred form of this invention is illustrated in the following drawings:

\FIG. 1 displays some winter tools that are popular;

FIG. 2 displays the winter tools camouflaged with fake ice sickles;

FIG. 3 shows a winter tool camouflaged in a field or yard.

### BRIEF DESCRIPTION OF THE PREFERRED EMBODIMENTS

There are a number of significant design features and improvements incorporated within the invention.

The invention is a winter tool such as a snow shovel that will be designed to fit in and be concealed by it surroundings and environment.

Winter tools 10 as shown in FIG. 1 have been around for thousands of years. There has always been issues on how and where to store them and make them visually appealing. The invention can be used with any number of winter tools and other tools that have the same needed.

The current invention will address this need as the winter tools 10. The winter tool could be painted white to match the environment of snow which allows the tool to be accessible but hidden in plain sight.

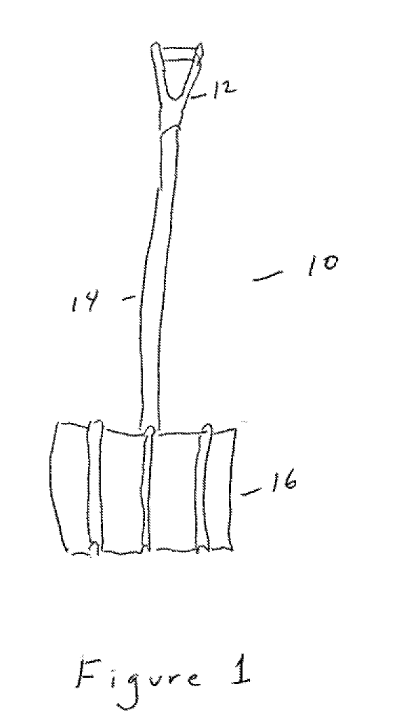

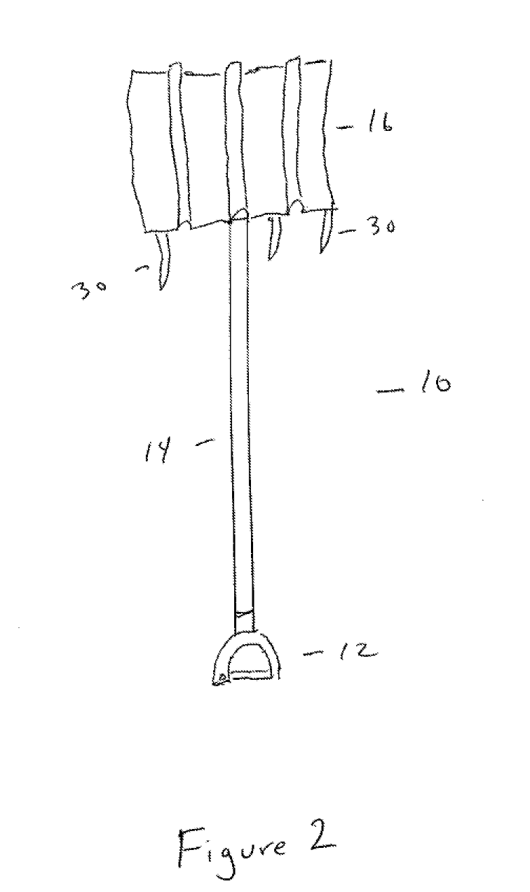

As shown in FIG. 2, the winter tools 10 are camouflaged with colors and texture or in this case with simulated white snow to much the desired environment. The winter tools 10 can also have imitation ice sickles 30 connected to it and/or around it to much the environment.

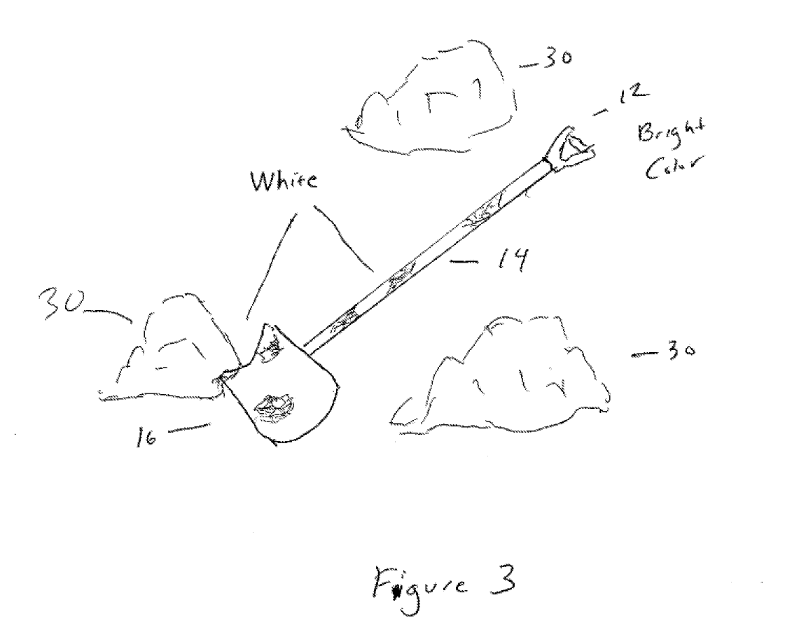

The coloring of the white tools 10 in the current invention would match environment and surroundings that the winter tools 10 would be in and stored in. The texture of the winter tools 10 could also match. The texture could be simulated snow. The coloring could be broken up as shown in FIG. 3 to assist in the camouflaging similar to military clothing. The handle 12 will be colored a bright color such as orange so that the winter tool 10 can be found. The handle 12 would be attached to a shaft 14 which would be round in the preferred embodiment but it could also be a flat rectangular shape. At the end of the shaft 14, the tool ending 16 such as a shovel blade would be attached. Other tool endings 16 can also be used.

FIG. 3 displays a winter in the snow 40 with the bright orange handle 12. The handle 12 would be a standard handle such as a Y-shape with a bar a cross the top of the Y to allow for the best hand hold.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A device comprising: a winter tool that is camouflaged with a bright colored handle.

2. The device system of claim 1 further comprising:
Where said winter tool is camouflaged is match a particular environment.

3. The device system of claim 1 further comprising:
Where said winter tool is camouflaged with coloring.

4. The device system of claim 1 further comprising:
Where said winter tool is camouflaged with texture.

5. The device system of claim 1 further comprising:
Where said winter tool is camouflaged with imitation ice sickles.

6. A process comprising: having a winter tool that is camouflaged with a bright colored handle.

7. The process system of claim 6 further comprising:
having said winter tool is camouflaged match a particular environment.

8. The process system of claim 6 further comprising:
camouflaging said winter tool with coloring.

9. The process system of claim 6 further comprising:
camouflaging said winter tool with with texture.

10. The process system of claim 6 further comprising:
camouflaging said winter tool with ice sickles.
